(19) United States
(12) Patent Application Publication
(10) Pub. No.: US 2012/0270197 A1
(43) Pub. Date: Oct. 25, 2012

(54) PHYSIOLOGY SIMULATION GARMENT, SYSTEMS AND METHODS

(75) Inventors: Brian C. Brost, Rochester, MN (US); Samuel J. Allen, Oronoco, MN (US); Thomas E. Belda, Rochester, MN (US); Eugene A. Mcgarry, Rochester, MN (US)

(73) Assignee: Mayo Foundation for Medical Education and Research, Rochester, MN (US)

(21) Appl. No.: 13/501,631

(22) PCT Filed: Oct. 12, 2010
(86) PCT No.: PCT/US2010/052341

§ 371 Date: Jun. 27, 2012

Related U.S. Application Data
(60) Provisional application No. 61/250,640, filed on Oct. 12, 2009.

(51) Int. Cl. G09B 9/00

(52) U.S. Cl. 434/267

(57) ABSTRACT

Physiology simulation garments, systems including physiology simulation garments, and methods of using the same are described herein.

### RELATED APPLICATION

The present application claims the benefit under 35 U.S.C. §119(e) of U.S. Provisional Patent Application No. 61/250,640, filed on Oct. 12, 2009 and titled PHYSIOLOGY SIMULATION GARMENT AND SYSTEMS INCLUDING SAME, which is hereby incorporated by reference in its entirety.

Physiology simulation garments, systems including physiology simulation garments, and methods of using the same are described herein.

The use of conventional mannequins and standardized patients in medical simulations can be problematic due to the lack of realistic interaction with mannequins and the lack of standardized physiologic conditions from standardized patients.

### SUMMARY

Physiology simulation garments, systems including physiology simulation garments, and methods of using the same are described herein.

The physiology simulation garments may be useful, e.g., in educational programs that train medical personnel to handle various physiological conditions (e.g., human physiological conditions) of a patient in a high fidelity (e.g., interactive) environment.

The garments, systems, and methods described herein may be used in, e.g., medical simulations for educational or research settings.

In some embodiments, the garments may be worn by a person, who may be a person who has been specifically trained (e.g., a standardized patient) to act the part (e.g., play the role) of a surrogate patient having the physiological conditions generated by the garment in medical simulation education and training.

In one aspect, some embodiments of a physiology simulation garment include a garment body adapted to be worn by a person; and a physiology condition generator operatively connected to the garment body, wherein the generator generates a selected sensory output indicative of a selected simulated physiological condition.

In some embodiments, the selected sensory output may include a selected auditory output. In some embodiments, the selected sensory output may include a selected visible output. In one or more embodiments, the selected sensory output may include a selected olfactory output. In some embodiments, the selected sensory output may include a selected somatosensory output.

In some embodiments, the generator simultaneously generates a plurality of selected sensory outputs. In one or more embodiments, the generator generates a plurality of selected sensory outputs that emit from different portions of the garment body.

In one or more embodiments, the garment may include an input sensing apparatus. In some embodiments, the input sensing apparatus may be capable of recording physiological sounds. In some embodiments, the input sensing apparatus may be capable of sensing the location of a probe proximal to the garment.

In one or more embodiments, the garment may include a torso section.

In some embodiments, the garment may also include one or more reservoirs operatively connected to the garment body. In one or more embodiments, at least one reservoir of the one or more reservoirs may include a fluid.

In another aspect, a system may be provided that includes one or more garments according to the present disclosure and a central instructing apparatus operatively connected to at least one of the one or more garments. In one or more embodiments, the central instructing apparatus may be operatively connected to at least one physiology condition generator of the one or more garments.

In some embodiments, a system may also include an eyewear simulation apparatus adapted to be worn by a person and operatively connected to the central instructing apparatus. In one or more embodiments, the system may also include a communication apparatus adapted to be worn by the person and operatively connected to the central instructing apparatus.

In one or more embodiments of the present disclosure, a system may include a central data receipt apparatus capable of receiving data transmitted from the one or more garments. In some embodiments, the central data receipt apparatus includes a display apparatus and/or a storage apparatus.

In one or more embodiments of the present disclosure, the system may be capable of synchronizing at least one selected sensory output of the physiology condition generator with an input to the input sensing apparatus.

In some embodiments, the system may also include one or more standard or modified diagnostic devices.

In another aspect, embodiments of methods of simulating a physiological condition are described herein, the methods comprising selecting a sensory output that is indicative of a selected simulated physiological condition; and generating the selected sensory output using a physiology condition generator operatively connected to a garment body.

In some embodiments of the methods described herein, the selected sensory output may be one or more of an auditory output (potentially generated by a speaker); a selected bioelectric signal; a selected visible output; a selected olfactory output; a selected somatosensory output; etc.

In some embodiments, the methods described herein comprise selecting a plurality of sensory outputs and generating the selected plurality of sensory outputs simultaneously from the garment body. In some embodiments, the selected plurality of sensory outputs emit from different portions of the garment body.

In some embodiments of the methods described herein, the selected sensory output comprises one or more selected images.

In some embodiments of the methods described herein, the method comprises recording the selected sensory outputs.

In some embodiments of the methods described herein, the method comprises generating the selected sensory output at a plurality of garment bodies, wherein each garment body of the plurality of garment bodies comprises a physiology condition generator operatively connected to the garment body, and wherein each garment body of the plurality of garment bodies is operatively connected to a central instructing apparatus.

In some embodiments of the methods described herein, the method comprises providing the selected sensory output using an eyewear simulation apparatus.

In some embodiments of the methods described herein, the method further comprises communicating instructions to a person wearing the garment body.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a garment may be used to refer to one, two, or more garments.

The term “and/or” means one or all of the listed elements or a combination of any two or more of the listed elements.

The above summary is not intended to describe each embodiment or every implementation of the physiology simulation garments, systems, and methods described herein. Rather, a more complete understanding of the physiology simulation garments, systems, and methods will become apparent and appreciated by reference to the following Description of Illustrative Embodiments and claims in view of the accompanying figures of the drawing.

### BRIEF DESCRIPTION OF THE VIEWS OF THE DRAWING

The physiology simulation garments, systems, and methods will be further described with reference to the views of the drawing, wherein:

FIGS. 1A-1E depict various exemplary embodiments of a garment;

FIG. 2 depicts a schematic diagram of an exemplary garment;

FIG. 2A depicts one embodiment of a physiological condition generator and a stethoscope; and

FIG. 3 depicts a schematic diagram of an exemplary system including a garment of the present disclosure.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments of physiology simulation garments, systems, and methods including the same. It is to be understood that other embodiments may be utilized and structural changes may be made without departing from the scope of the present invention.

Providing realistic training opportunities to trainees (e.g., medical personnel and/or medical students) can be challenging. In some circumstances, the “patient” for training purposes is an inanimate object (e.g., a “dummy”) that is, e.g., incapable of providing feedback to a trainee and to which the trainee may find difficulty practicing patient communication skills. In some circumstances, the “patient” is a person who may or may not have the physiological condition that is the subject of the training exercise, which presents challenges to educators seeking to, for example, provide standardized training situations. It may be difficult to present a standardized physiological condition to a large number of trainees for purposes of, e.g., evaluating the responses of the trainees or training a group of trainees (e.g., first responders) for a large-scale medical situation.

The garments, systems and methods described herein may provide, e.g., repeatable simulated physiological conditions. Further, a garment of the present disclosure may be adapted to be worn by a person who need not have the physiological condition, but who may play the role of a person who does, which may provide a more realistic and standardized training exercise.

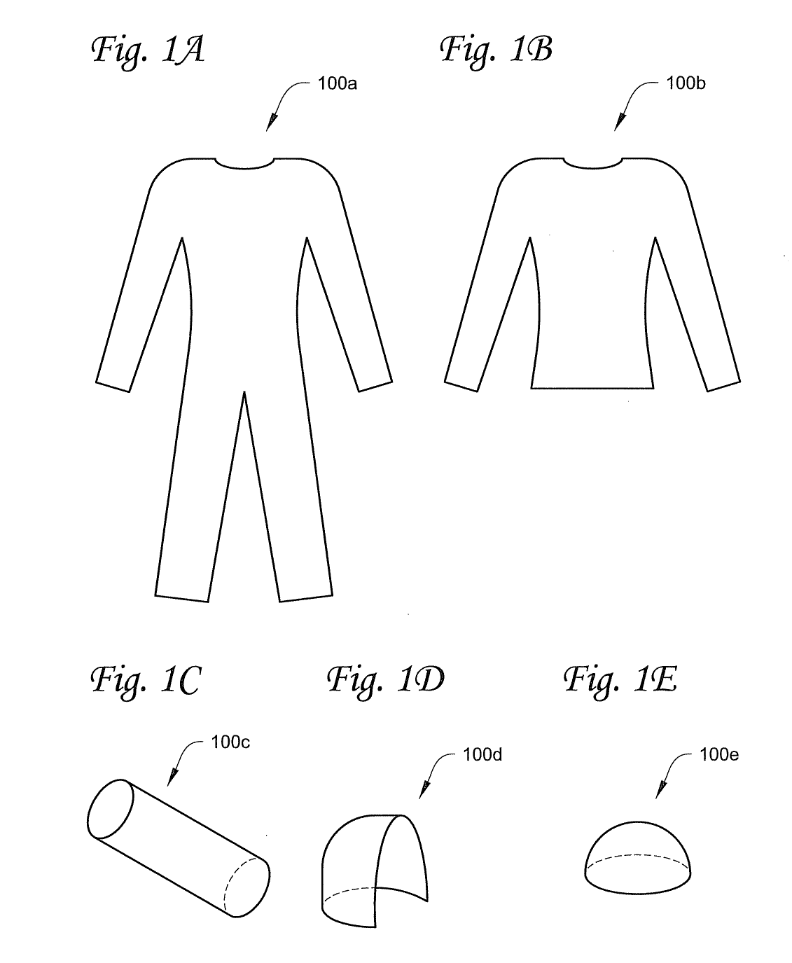

One embodiment of a physiological simulation garment 100a is depicted in FIG. 1A and its various features (e.g., optional features) will be described herein. The garment 100a in FIG. 1A includes a bodysuit-type design and is adapted to be worn by a person. The garment 100a includes a torso section, a lower-body section, two sleeve sections, and two pant sections. Although not shown in FIG. 1A, the garment 100a may further include sections that cover one or both hands and/or one or both feet. The garment 100a may further include a head section, which would cover at least a portion of a person's head when worn by a person. Alternately, a garment of the present disclosure may be adapted to cover the entire body of a person.

In some embodiments, a garment may be as shown in FIG. 1B in which the depicted garment 100b is of a design that includes a torso section and two optional sleeve sections, the garment being adapted to be worn by a person.

In one or more embodiments, a garment of the present disclosure may include other designs. For example, as shown in FIG. 1C, a garment 100c may take the tube-like shape having a lumen passing from one end of the garment to an opposite end. Such a garment 100c may be adapted to be worn by a person, for example, as a sleeve or portion thereof (e.g., an elbow covering), as a pant or portion thereof (e.g., a knee covering), or as a tube-like garment which may be worn around the torso (e.g., upper thorax, lower thorax, around a rib cage and/or abdominal section of a person).

FIGS. 1D and 1E depict other exemplary designs of garments 100d and 100e of the present disclosure for covering, for example, a portion of a head in a hood configuration (FIG. 1D) or a hat/cap configuration (FIG. 1E).

Other various designs of garments will be known to those skilled in the art and will not be further described in detail herein.

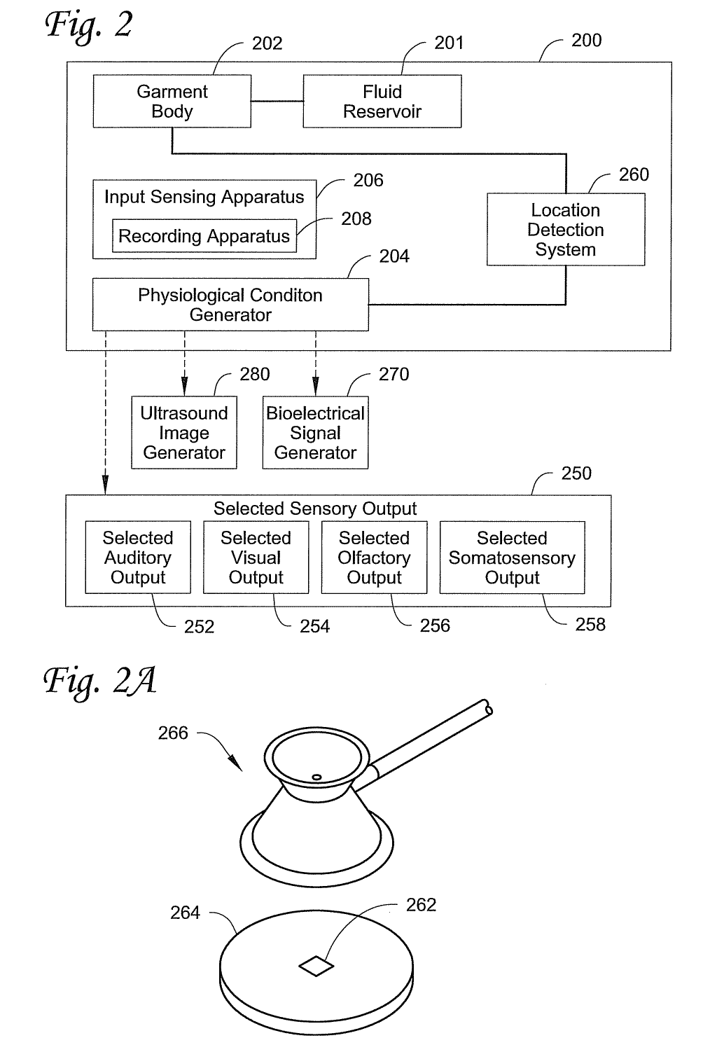

The physiology simulation garment 200 depicted schematically in FIG. 2 includes a garment body 202 adapted to be worn by a person, placed on a mannequin or task trainer, etc.; and a physiology condition generator 204 operatively connected to the garment body 202, wherein the generator 204 generates a selected sensory output 250 indicative of a selected simulated physiological condition.

The garment body 202 of the physiology simulation garment 200 may be made from any useful material (e.g., woven, nonwoven, synthetic, natural, polymer, etc.). It should be noted that the physiology simulation garment 202 depicted in FIG. 2 may take any form, such as, e.g., the embodiments depicted in FIGS. 1A-1E.

In one or more embodiments, the garment body 202 may be adapted to be worn by a person of any age (e.g., a child, an adult, etc.) and of any dimensions or build (e.g., short, tall, large, small, broad, thin, etc.).

In one or more embodiments, the garment body 202 may include artificial limbs in the form of standalone pieces or modules that may be attached to the simulation garment for the simulation of nerve conductions that can be interpreted through the use of, e.g., electromyography (EMG)signals that may be generated as described herein.

In some embodiments, the physiology condition generator 204 generates a selected sensory output 250 that may include an output capable of being perceived by at least one of the human senses. For example, the selected sensory output 250 may include one or more of the following: a selected auditory output 252 (i.e., sensed by an observer's sense of hearing); a selected visible output 254 (i.e., sensed by an observer's sense of sight); a selected olfactory output 256 (i.e., sensed by an observer's sense of smell); and a selected somatosensory output 258 (i.e., sensed by an observer's sense of touch).

The physiology condition generator may be capable of generating a wide range of selected sensory outputs 250.

For example, the selected auditory outputs 252 may include heart sounds (e.g., normal to irregular), lung/breath sounds (e.g., normal to irregular), pulses having various rates, rhythms, and intensity, bowel sounds, flatulence, eruptions, hiccups, etc. Other selected auditory outputs may include sounds associated with pregnancy such as fetal heart tones (FHTs). Selected auditory outputs may also include jugular venous pressure (JVD) pulsations and bruits.

In one or more embodiments, the selected auditory outputs 252 may include audible sounds generated via sound drivers (e.g., speakers). For example, a standard stethoscope and physical inspection may be utilized to perceive sounds that are detectable through conventional auscultative means (e.g., ear to chest and/or stethoscope to thorax, etc.). The selected auditory outputs 252 may also include, for example, presentation of location specific physiologic sounds that may be triggered by, e.g., placement of a stethoscope (or other device) at a selected location on or near the garment 200 (e.g., placement of a stethoscope chestpiece within known regions of the thorax may trigger the delivery of feedback to a trainee through a specially configured stethoscope). The selected auditory output 252 (e.g., playback of sounds) may include an overlay of blended and synchronized sounds specific to a selectable and scripted condition and location.

The physiology simulation garment 200 may also include a location detection system 260 such that the system can detect when and where a device (such as, e.g., a stethoscope, etc.) is placed on the physiology simulation 200. The location detection system 260 may use any suitable technology such as, e.g., radio frequency antennae signals (RFID), ZigBee, Bluetooth, personal network referencing technology, etc.

The physiology condition generator 204 may include one or more speakers for playback of, for example, heart, lung, and bowel sounds. The generator 204 may also include location identifying sensors that trigger sounds from a library within a conventional stethoscope (auscultation device) or a proprietary listening device (e.g., a modified stethoscope). The physiology condition generator 204 may include a sound database in a compressed audio format and may also include a solid state storage device (e.g., flash media) which may be on board the listening device (e.g., stethoscope) and/or on a central instructing apparatus, discussed further herein. The physiology condition generator 204 may include speakers directly on the garment body 202 for basic assessment of emanating sounds.

In some embodiments, the physiology condition generator 204 may also include a bioelectric signal generator 270 capable of providing signals corresponding to those generated innately be biological tissue. Examples include, but are not limited to electrocardiogram (ECG) signals, electromyogram (EMG) signals, electroencephalogram (EEG) signals, etc. In the case of EEG signals, for example, the signals generated may represent variable but selectable neurological states and conditions. The EEG signals may be generated by a cap worn by a human actor, a mannequin, etc. The EMG signals may be generated using, e.g., an external EMG probe superficially and/or through deep nerve conduction simulation through the use of an internally placed needle electrode (in the case of a mannequin or artificial limb-based simulation). Positioning of the probes may be determined using the location detection systems described herein.

As seen in FIG. 2A, a position sensor 262 and a physiology condition generator 264 may be combined in a single device that is adapted to be used with, e.g., a conventional stethoscope 266. The physiology condition generator 264 may be attached to the stethoscope by any suitable technique, e.g., clips, adhesives, magnetically, etc. The position sensor 262 preferably communicates with, provides a signal to, or is detected by the location detection system 260 when placed on or near the garment 200. Once the position of the stethoscope 266 is known, the physiology condition generator 264 can be used to generate an auditory signal that can be heard by a trainee using the stethoscope 266. As discussed herein, the auditory signal delivered by the generator 264 can be selected based on the position of the stethoscope relative to the garment 200. Although the position sensor 262 is depicted as incorporated into the physiology condition generator 264, it may be provided separately.

In some embodiments, the physiology condition generator 204 may also include an ultrasound image generator 280 that may be capable of generating images from, e.g., a library of images, that can be selected based on a variety of factors such as, e.g., detection of the placement of an ultrasound probe at one or more selected locations, movement of the probe in one or more selected directions, etc. The probe used in such an embodiment may also include a position sensor (as discussed above in connection with the stethoscope of FIG. 2A) that, in combination with the location detection system 260, provides information regarding the location of the probe on or near the garment 200 such that selected images can be displayed to a trainee. The images may allow for the underlying anatomy to be represented with a controlled set of images (where images include video clips) corresponding to a clinical condition or pathology. The images displayed to the trainee may allow for different clinical scenarios or differential diagnosis to be obtained during simulation exercises using human actors, mannequins, etc.).

In some embodiments, a selected visual output 254 may include changes in skin tone which may include the skin changing color to reflect pallor, flush skin, cyanosis (blue or purple hues), mottling, erythema, icterus, bruising, rashes, nail bed changes, and/or to reflect patient ethnicity. In some embodiments, a selected visual output 254 may include a rising or falling chest (e.g., simulating serious tachypneic patient and/or other significant respiratory distress, etc.), alopecia, and skin conditions such as lesions, rashes, blisters, and ulcers. Other selected visual outputs 254 may include the appearance of a bodily discharge, which may include, for example, perspiration, lacrimation, ear fluids (e.g., cerebrospinal fluid, etc.), nipple discharge, venous/arterial bleeding conditions (e.g., post partum hemorrhage), abrasion oozing, rectal and urinary incontinence, fistula, nasal bleeding or discharge, emesis, hematemesis, bile, etc. In some embodiments, a selected visual output 254 may be in the form of an electronic visual display (e.g., using technologies such as LED, LCD, etc.) to display changes on extremities or separately on an external display. Other selected visual outputs 254 may include jugular venous pressure distention (JVD) location and pulsations, etc.

In one or more embodiments, a selected olfactory output 256 may include odors typical of a body including, but not limited to ketoacidosis, halitosis, flatulence, perspiration, fungal odors, blood odors, etc.

In some embodiments, a selected somatosensory output 258 may include any physiological condition that can be perceived by touch. For example, some exemplary somatosensory outputs 258 may include, but are not limited to pulmonary conditions (e.g., feeling chest rise and fall), cardiac conditions (e.g., pulse rate, rhythm, and intensity), bowel activity, skin turgor and perfusion assessments, skin or surface temperatures (e.g., hot, warm, cool, cold, fever, hypothermia, normal, etc.), skin dryness or skin wetness (e.g., perspiration, bleeding, discharge, etc.), the presence of tissue masses (e.g., breast masses), gynecomastia, tissue density changes, tissue perfusion indications, restriction of range of motion due to joint swelling or general inflammation. Other selected somatosensory outputs 258 may include physical changes to abdominal organs such as a liver edge, which may be simulated with interchangeable fitted pieces to be inserted into the garment, which may represent interactive elements for the standardized patient to indicate pain or a specific interpreted sensation on pressure or physical examination. In one or more embodiments, an external lung component or module may be worn for representation of significant respiratory distress, which may signal a chest rise and fall in serious tachypneic patients and/or synchronize with breath sounds and dynamic lung conditions.

In some embodiments, the selected somatosensory output 258 may include a localized output such as an artificially simulated temperature change in a localized portion of the garment, which may represent, for example, an infection or poor cardiac perfusion. In one or more embodiments, the selected somatosensory output 258 may include a temperature output from standard sites, which may be measured, for example, with a thermometer, such standard sites including aural, rectal, oral, axillary, etc., with precise reflection of an artificial body temperature. Other selected somatosensory outputs 258 may include liver or spleen enlargement, peripheral pulses, deep tendon reflexes, hand/nail findings, edema, arthritis (e.g., joint pain, limitation of range of motion, redness, warmth), piloerection (e.g., goose pimples or cutis anserina), nuchal rigidity, etc. Other selected somatosensory outputs 258 may include conditions associated with pregnancy such as fundal height. Other selected somatosensory outputs 258 may include changes in tissue shape or mass such as edema, fluctuant to solid objects (including, but not limited to, e.g., dislocated bone, liver, uterus, spleen, hematoma, etc.), rash, vesicles, blisters, healing incision, granulation tissue, nail bed changes, cardiac pulses, chest/abdominal movement with breathing, piloerection, and alopecia.

The selected sensory outputs 250 from the chest portion of a torso section of a garment may include selected sensory outputs 250 related to electrocardiogram (ECG) rhythms, heart sounds, lung sounds, and conditions of the breast such as breast masses, skin changes, gynecomastia, nipple discharge, etc.

The selected sensory outputs 250 from the abdomen portion of a torso section of a garment may include sensory outputs related to bowel sounds, aorta pulsations/aneurysm, pregnancy findings (e.g., fetal heart tones (FHTs), fundal height, etc.), liver or spleen enlargement, bladder enlargement, bowel obstruction, male/female genitalia, peritoneal signs, etc.

The selected sensory outputs 250 from the head and neck portion of a garment may include sensory outputs related to jugular venous pressure, jugular venous distention, location, pulsations, and bruits, lacrimation, exophthalmos, pupil/retinal findings, ear findings such as cerebrospinal fluid, nasal findings such as bleeding and nasal discharge, nasal pharyngeal, oral and neck findings such as, e.g., emesis, hematemesis, bile, cough, stridor, hoarseness, nuchal rigidity, etc.

The selected sensory outputs 250 from the extremities portion of a garment may include sensory outputs related to peripheral pulses, peripheral perfusion, deep tendon reflexes, hand/nail findings, blood pressure cuff findings, edema, arthritis (e.g., joint pain, limitation of range of motion, redness, warmth, etc.), etc.

The selected sensory outputs 250 from any portion of a garment that represents skin may include sensory outputs related to skin temperature (hot, warm, cool, cold, etc.), skin coloring (pallor, flush, cyanosis, mottling, etc.), skin moisture (wet, dry, etc.), piloerection, alopecia, lesions, rash, blisters, ulcers, etc.

In one or more embodiments, the physiology condition generator 204 may simultaneously generate a plurality of selected sensory outputs 250, which may emit from the same or different portions of the garment body 202. For example, for a given pathological condition to be simulated, a plurality of selected sensory outputs 250 may be generated from one or more portions of the garment body 202. For example, simulating a heart attack may include generating selected auditory outputs 252 such as cardiac and pulmonary sounds, generating selected somatosensory outputs 258 such as varying the pulse characteristics (e.g., rate, rhythm, and intensity) and generating perspiration, and/or selected visible outputs 254 (e.g., skin color changes).

Localization feedback (e.g., correlation between selected auditory output 252 and placement of stethoscope chestpiece) may provide an operator with high confidence monitoring of the findings detected by the trainee during a physical exam. In some embodiments, real-time detection and playback may be simultaneously available to an operator (e.g., an operator inside or outside of the simulation room) who may be controlling and monitoring the simulation experience. The feedback may be captured as part of an integrated debrief record and then may be reviewed post encounter. This establishment may allow better standardization and review of the record of the actual events experienced by the trainee for better clarity and fidelity in the review of actions and learning in the simulation environment.

In one or more embodiments of the present disclosure, the garment 200 may also include an input sensing apparatus 206. In the present disclosure, an input sensing apparatus 206 may include recording apparatus 208 that is capable of recording physiological sounds and/or other symptoms generated by a person wearing the garment. Such sounds and/or other symptoms may then be stored and made available for future simulations of the recorded physiological conditions.

In some embodiments, the input sensing apparatus 206 may record and catalogue a library of normal patient physiology and pathology. The input sensing apparatus 206 may record actual patient data (e.g., true human physiologic representations of breath, heart, intrathoracic, and abdominal sounds, etc.) that may be used in conjunction with or may replace software programming using formulas that may only estimate the actual clinical human physiology and pathology (e.g., breath sounds, cardiac sounds and pulsation, chest excursion, etc.). The input sensing apparatus 206 of the present disclosure may be improved relative to conventional simulation systems by, for example, recording and cataloguing variations in patent age, gender, body characteristics, clinical conditions, response to medications, etc. In contrast, some conventional mannequins and standardized patients may replay the same sounds (e.g., the same audio file) and may not be able to display or alter physiology or pathology unless the standardized patient actually has the physiology or pathology.

In some embodiments, a library of normal patient physiology and pathology generated from one or more input sensing apparatus 206 may be utilized in experiential learning. In one or more embodiments, the garment 200 (e.g., worn by mannequin or a standardized patient) may be capable of outputting one or more of the catalogued normal or pathologic states while masking the physiology of the standardized patient. The input sensing apparatus 206 may allow detection, listening, etc., of the, for example, complex interplay or sounds in the human body (e.g., change in breath/heart sounds with differing auscultation areas, interplay between maternal, placental, and fetal heart rates, etc.) based on where the trainee (e.g., learner) listens to the garment.

In one or more embodiments of the present disclosure, the input sensing apparatus 206 may record all the sounds, movements, etc. associated with pathology, which may be further researched to locate improved locations for examination (e.g., auscultation, palpation, etc.) of normal physiology and pathologic conditions, which may lead to standardized education around the results of the research.

In some embodiments, the input sensing apparatus 206 may include structure in the garment body 202 that is capable of sensing the location of a probe proximal the garment. In one or more embodiments, the garment body 202 may include one or more sensors that may be used to determine placement of stethoscope chestpiece and detection of pulse and other assessment features for proper positioning, or placement of, for example, paddles for cardioversion. For example, the garment body 202 may include various sensors that, either individually or collectively, are capable of determining a location of, for example, a stethoscope chestpiece (e.g., stethoscope head). The location of the stethoscope chestpiece could be determined using, for example, magnetic readings, electromagnetic readings, or other location determining methods that are known to those of skill in the art. An electronic auscultation system for a patient simulator utilizing electro-magnetic transmitters in a mannequin to locate a stethoscope chestpiece for generating sounds may be disclosed in U.S. Pat. No. 6,220,866 (Amend et al.) and documents cited therein. In some embodiments, the input sensing apparatus 206 that is capable of sensing the location of a probe proximal the garment body 202 may include one or more pressure sensors that can measure the application of pressure by a probe (e.g., a fingertip, palm, hand, etc.) against the garment body 202 whereby the location of the applied pressure may be determined.

In one or more embodiments, the garment body 202 includes one or more optional fluid reservoirs 201 operatively connected to (e.g., contained in, under, on the exterior of, etc.) the garment body 202. In some embodiments, at least one fluid reservoir of the one or more reservoirs contains a fluid. In some embodiments, one or more reservoirs may be built into the garment body 202 or may be separate from the garment body 202 and in fluid communication with the garment body 202 through one or more tubes and one or more liquid ports in the garment body. In some embodiments, a garment body 202 may include tubing and one or more pumps or other fluid delivery apparatus such that one or more fluids could be delivered from one or more reservoirs to the garment body (e.g., to the surface of the garment body 202 to simulate a release of fluid such as perspiration, blood, urine, etc.). A wide variety of fluid delivery systems may be suitable for use in some embodiments of the garments.

In the present disclosure, a fluid may include any material suitable for delivering from a reservoir to the garment body and includes, but is not limited to, a gas and/or a liquid. A liquid may or may not also include solid material which may be present, for example, in an emulsion, suspension, or slurry.

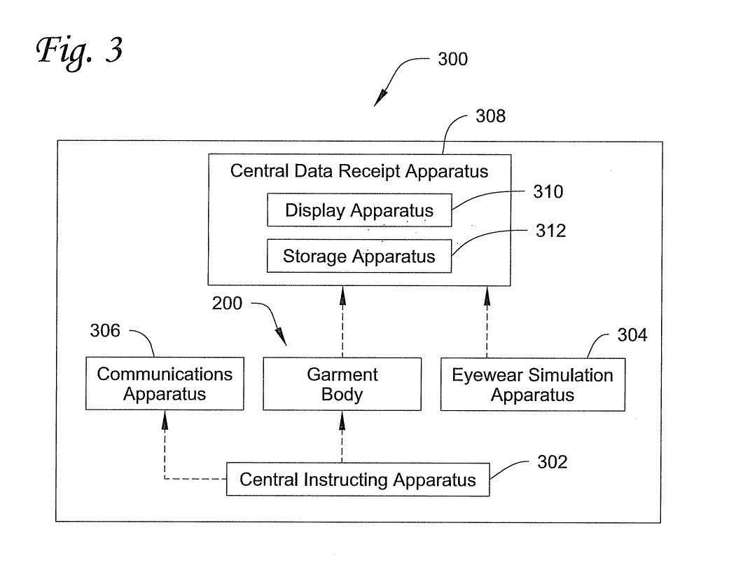

Turning to FIG. 3, in another aspect of the present disclosure, a system 300 is provided that may include a physiology simulation garment 200 as described herein and a central instructing apparatus 302 operatively connected (shown as dashed line in FIG. 3) to at least one of the one or more garments 200.

A central instructing apparatus 302 may provide various instructions to the garment (e.g., to a physiology condition generator) to generate one or more selected sensory outputs 250. The central instructing apparatus 302 may be operatively connected to one or more garments 200 by a wired connection and/or a wireless connection (e.g., infrared, Bluetooth, etc.). For example, the garment 200 may include, e.g., a radio frequency (RF) receiver for receiving instructions or commands from the central instructing apparatus 302.

The central instructing apparatus 302 may be programmed to provide a set of instructions that may be separated in time. The central instructing apparatus 302 may also be operated by an operator (e.g., an instructor or commander) who may, for example, manipulate the variables of a standardized patient's physiological state using a computer software interface. Instructions may be delivered via pre-scripted timeline-based formats or may be managed in a just-in-time fashion. In some embodiments, the central instructing apparatus 302 may include integrated templates for scenario development and delivery may be provided for medical simulation education, wherein the templates may allow modifications of conditions to be reconfigured for individualized use and replicated in a standard way for education and training trainees (e.g., medical professionals).

One or more embodiments of the system may also include an eyewear simulation apparatus 304 adapted to be worn by a person and operatively connected to the central instructing apparatus 302. In some embodiments, the eyewear simulation apparatus 304 may include vision altering eyeglasses (e.g., may cause standardized patient wearing the eyewear to experience double vision or blurring) that may respond to different requirements for different situations. For example, eyewear simulation apparatus 304 (e.g., wearable eyeglasses, a monocle, goggles, etc.) may be capable of creating LCD representations of blinking eyes that move in synchrony with the eye movements of a person wearing the wearable eyeglasses. In some embodiments, the eyewear simulation apparatus 304 may depict eyes showing bleeding, pupillary reactions to medications or vascular conditions. In some embodiments, exams of retinas may be performed by trainees by looking at the eyewear simulation apparatus 304. In some embodiments, the eyewear simulation apparatus 304 (e.g., eye “display glasses”) may track actual movement of a standardized patient's eye movements allowing a visual representation of the eye for examination purposes.

In some embodiments, the eyewear simulation apparatus 304 may be operatively connected with the physiology condition generator 204 of the garment 200. In such embodiments, the eyewear simulation apparatus 304 may display the selected sensory outputs generated by the physiology condition generator 204, such as eye color, lacrimation, exophthalmos, and pupil and/or retinal findings.

In one or more embodiments of the present disclosure, a system 300 may include goggles and/or inserts to allow clinical and/or pathological findings related to the mouth, nose, eyes, etc.

In one or more embodiments, a system 300 may further include a discreet camera adapted to be worn by a standardized patient, wherein the camera may capture perspective of the trainee from the view of the patient for purposes of augmenting debrief of scenarios.

In some embodiments, the system may also include a communications apparatus 306 adapted to be worn by a standardized patient and operatively connected to the central instructing apparatus 302. The communications apparatus 306 may include a discreet ear receiver that can, for example, play the cadence of the heart rate (pulse) and breath sounds (rate and effort) as a guide for the standardized patient to follow. Alternatively, respiratory sounds played by the communications apparatus 306 may be synchronized to the respiratory rate and effort (monitored with, for example, inductance plethysmography or cadence delivered via wireless receiver and ear piece) of the standardized patient. The communications apparatus 306 may also allow the central instructing apparatus 302 to communicate other instructions to the standardized patient. For example, the central instructing apparatus 302 may communicate to the standardized patient which of the physiological conditions will be simulated such that the standardized patient may be ready to play the role of a patient exhibiting such a physiological condition. The communications apparatus 306 may also be utilized such that the operator may coordinate patient responses to questions or stimulate interactions between the standardized patient and the trainee.

In one or more embodiments, the communications apparatus 306 may include noise canceling technologies for creating auditory deficits (e.g., limiting hearing in certain ranges of frequencies). For example, a communications apparatus 306 may include ear plugs that may be used to dampen sound or limit certain frequency ranges.

In some embodiments, the communications apparatus 306 may include perceivable stimulus (e.g., gentle tactile stimulus) to communicate to the standardized patient the location, progression, and movement of a pain, etc.

In one or more embodiments of the present disclosure, a garment 200 may be worn by a standardized patient, presenting a situation in which a trainee may experience real-life and enhanced interactions with the standardized patent. Conventional mannequins do not look or respond realistically and standardized patients that are not wearing a garment of the present disclosure may not have a particular pathology or physiology of the pathology. In one or more embodiments, a standardized patient may be made aware (via a communications apparatus 306) of where a pain, itching, etc. may be, may experience visual (double vision, blurring, etc.) and auditory (tinnitus, loss of range of hearing frequency, etc.) changes, which may be further synchronized with simulated physiologic findings (e.g., tachypnea), and may be capable of providing a more realistic portrayal of the scenario. In one or more embodiments, a garment 200 may allow physiological changes (e.g., clinical findings) to be simulated rapidly in response to therapeutics or management. One or more systems of the present disclosure may also enhance the learning opportunity of the trainee by, for example, allowing interaction from visual replay from a patient perspective (e.g., from a camera) or by actually wearing the garment 200 (e.g., suit) to experience pathological findings.

The garments 200 and systems 300 of the present disclosure may also document not only improve the level of knowledge and understanding of the trainee regarding complex physiologic processes, but application of the trainee's ability to gather physical findings and applying knowledge in a clinical setting (e.g., properly performing procedures and interpreting within the clinical history the diagnosis, management, change in clinical condition, etc.). Some embodiments of the present disclosure may also allow for standardization (important for credentialing, certification, Board certification, maintenance of certification, etc.) of a clinical presentation to a group of trainees (e.g., learners or examinees), while being able to rapidly convert between physiologic or pathologic states. One or more embodiments may be readily adaptable to multiple patient/mass casualty scenarios requiring coordination of signs symptoms (e.g., building fire with smoke inhalation, mass trauma, poisoning or gas exposure, etc.). In one or more embodiments, physiologic conditions may represent a consistent but changing clinical representation such as in mass casualty or bio-terrorism scenarios wherein a large number of individuals may have been exposed to a known or unknown substance and may require triage and treatment under prescribed training conditions. One or more embodiments of the present disclosure may be used in conjunction with current technologies including mannequins and task trainers to allow for procedural skill training and competency.

In one or more embodiments, a system 300 may include a central data receipt apparatus 306 capable of receiving data transmitted from the one or more garments 200. In some embodiments, the data transmitted from the one or more garments 200 may be transmitted via a wire or wirelessly.

In one or more embodiments, the central data receipt apparatus 306 may include a display apparatus 310 and/or a storage apparatus 312. A display apparatus 310 may include, for example, a computer screen that may display some or all of the data transmitted from the garment 200 to the central data receipt apparatus 308. For example, any data related to the selected sensory outputs 250 of the physiology condition generator 204 (e.g., ECG, pulse, respiration, temperatures, etc.) or any other data collected by the input sensing apparatus 206 may be displayed. In the present disclosure, a storage apparatus 312 may include any suitable type of memory for storing data transmitted from the one or more garments, including, but not limited to, a solid state memory device, flash memory, RAM, ROM, hard drive memory, the output from a printer, etc.

In one or more embodiments, the system 300 may be capable of synchronizing at least one selected sensory output 250 of the physiology condition generator 204 with an input to the input sensing apparatus 206. For example, the system may be capable of synchronizing a selected sensory output 250 associated with a heart pulse (or respiratory rate and/or effort) from the physiology condition generator 204 with a pulse reading (or reading of respiratory rate and/or effort) of the standardized patient to the input sensing apparatus 206. In some embodiments, one or more selected sensory outputs 250 of the physiology condition generator 204 are not synchronized with any input to the input sensing apparatus 206. In one or more embodiments of the present disclosure, the system 300 may synchronize heart sounds and rhythms with ECG and blood pressure tracings and other indications of physiological state.

In some embodiments, the system 300 will also include one or more standard or modified diagnostic devices or devices designed to be added to or used with conventional devices (e.g., position sensors/equipment, auditory playback equipment, electrical signal generators, etc.). In the present disclosure, a standard diagnostic device means a medical device that may be useful in actual medical diagnostics or treatment situations (e.g., a conventional stethoscope, otoscope, etc.). In the present disclosure, a modified diagnostic device means a medical device that has been modified, for example, for use with a garment 200 and/or systems described herein. For example, a standard diagnostic device may include a stethoscope, whereas a modified diagnostic device may include a stethoscope-like device that has been modified to store and play a library of sounds that may be heard with a standard stethoscope. The stethoscope may, for example, incorporate a digital audio playback device (e.g., MP3 player, iPod, etc.) that can play selected audio clips). Such a modified stethoscope may pay sounds based on the specific location of the stethoscope chestpiece on the garment (where. the location may be detected using, e.g., a location detection system as described herein). Other standard or modified diagnostic devices may include, for example, modified paddles to simulate a cardioversion treatment, otoscopes that incorporate a display, etc.

A wide variety of other standard or modified diagnostic devices are suitable for use with the garments 200 of the present disclosure and will be known to those of ordinary skill in the art.

In some embodiments, a system 300 may include one or more garments 200 that are capable of communicating with one or more other garments 200. For example, a central instructing apparatus 302 may provide instructions to one or more other garments 200 which may include instructions to relay instructions to one or more other garments 200 in real-time and/or with a time delay. In this manner, the system 300 may instruct a plurality of garments 200 to exhibit physiological conditions (e.g., selected sensory outputs 250) in a coordinated manner that may simulate, for example, transmission of a contagious disease or a delayed reaction to a common simulated stimulus.

In one or more embodiments of the present disclosure, a central instructing apparatus 302 may be the same as or different from the central data receipt apparatus 308.

One or more embodiments of the present disclosure may be provided in the following discussion.

In one or more embodiments, the present disclosure provides a wearable garment 200 (e.g., a suit/material) that allows artificial representation of dynamic human physiology. The garment (e.g., suit) may respond to computer control (e.g., from a central instructing apparatus 302) to create the ability to show various patient conditions that can be monitored (and assessed) by trainees (e.g., health care students and workers), for example, for the purpose of medical simulation education. Heart rate and rhythm, ECG, EEG, EMG, pulse rate and quality, respiration rate and pattern, cardiac perfusion and many other parameters may be represented. The garment 200 (e.g., suit) may allow for human-to-human interaction as part of the normal patient-to-health care provider relationship which may not currently be available as a means for high fidelity patient assessment. Civil disaster and/or military applications may also be possible for, for example, mass casualty scenarios with distributed delivery of human physiological parameters in response to biohazard and other types of mass or pandemic evolving disease conditions.

Medical simulation is a relatively new concept in education that follows in the traditions of aviation simulation and other high reliability organizations. Medical simulation may be incorporated by institutions to provide high level education and may enhance the safety of delivery of health care. Technology may play a large role to create the realism of medical care environments and the representation of realistic clinical encounters for the trainees (e.g., learners and participants). Unfortunately, technology to date can only bring us so close and may not adequately accommodate the human interaction to provide realistic patient and care-provider scenarios. Standard simulation platforms and mannequins may have distinct limitations. One or more embodiments of the present disclosure may overcome one or more of these shortcomings and may provide an entirely new platform from which to train trainees (e.g., healthcare providers).

One or more embodiments of the present disclosure may include a technology platform that may be used in combination with the skills of a standardized patient (e.g., human actors) who may portray patients with one or more (e.g., an array of) human physiologic conditions. The garments 200 of the present disclosure may be worn in-part, or as a whole by standardized patients (e.g., human actors), allowing the assessment of normal and abnormal physiologic conditions. A communications apparatus 306 (e.g., a communications module within the suit) may allow 2-way discreet communications between the standardized patient and, for example, an operator (e.g., faculty or technical staff) who may manipulate the variables of the standardized patient's physiologic state using a computer software interface (which may be a part of central instructing apparatus 302 described herein). Assessment of the standardized patient may be performed by the trainees (e.g., learner(s)) using standardized monitoring equipment as well as physical and manual inspection consistent with current medical practice. Various aspects (e.g., modules) from the garment (e.g., simulation suit) may be used in parallel with current simulation mannequin technology to augment and improve upon the shortcomings of conventional human patient simulation mannequins.

In some embodiments, the garments 200 and/or systems 300 of the present disclosure may be used in conjunction with mass casualty or disaster response (multi suit control of parameters).

In one or more embodiments of the present disclosure, garments 200 and/or systems 300 may include advanced but discreet technology that may deliver the ability to overlay a pseudo representation of a wide variety of physiologic parameters (e.g., those described herein), when presented in context with other symptoms that may be provided by the standardized patient (e.g., actor) may deliver a training platform for trainees (e.g., students) to determine a differential diagnosis for a wide variety of combination of pathologic disease states.

Assessment conditions include a wide variety of selected sensory outputs 250 that include, but are not limited to: heart sounds (e.g., normal to irregular, a wide variety of combinations); breath sounds (e.g., normal to adventitious, a wide variety of combinations and types); pulses (e.g., rate, rhythm, intensity, etc.); bowel (e.g., activity and sounds); skin (tone, turgor, perfusion assessments, etc.); temperature (e.g., skin or surface temp, perspiration, etc.); tissue (e.g., masses, density changes, color changes, perfusion indications, etc.); innate bioelectric activity (e.g., ECG, EEG, EMG, etc.).

In one or more embodiments, garments 200 and/or systems 300 may limit or reduce the factors and external variables that may make delivering a patient scenario difficult to perform for the standardized patients (e.g., actors), while enhancing the reality for the trainees (e.g., learners). The garments 200 and/or systems 300 of the present disclosure may meet various educational goals for training trainees (e.g., medical staff and students) to achieve acceptance and high satisfaction for both operators (e.g., faculty) and trainees (e.g., learners) expectations in simulation. The garments 200 and/or systems 300 of the present disclosure may improve outcomes from simulation based education, may increase the reality of simulation experiences, and may standardize the mechanism for dynamically delivered medical education via simulation.

One or more embodiments of the present disclosure may include a flexibility to provide interaction with operators (e.g., task trainers, etc.) for continuum of care. Some embodiments may include an apparatus to provide one or more types of information regarding logistics and locations, for example, a global positioning system (GPS) location function which may be built into the garment 200 and may allow for visually detecting the location of garment (e.g., standardized patent wearing the garment). One or more embodiments of the present disclosure may also include an accelerometer to record and report the position and/or movements of a standardized patient (e.g., an actor/patient).

One or more embodiments of the present disclosure may include a wide variety of additional technologies. For example, a microphone for audio capture may be included (e.g., embedded) in a garment 200 (e.g., a suit) or on a person, which may be included within a multi-channel system wirelessly mixed down that could be routed to any of one or more listening positions.

One or more embodiments of the present disclosure may include remote control capability, such as laptop computer, tablet computer (e.g., personal computer), cellular telephone, etc. control of some or all functions that may use a heads up display (HUD) over a wireless proprietary and/or local area network.

One or more embodiments of the present disclosure may include incorporation of electrochemical and/or electrosensitive “chameleon technology” fabric to change appearance and rigidity of tissue and/or dermis in a garment 200.

Some embodiments of the present disclosure may include display capabilities (e.g., LCD) to display the state and condition of patient (e.g., images or data values that may represent, for example, ECG, SP02, NIBP, Korotkoff sounds, etc.), which may include showing images on the display to represent a condition that is visible to the care provider. In addition, some embodiments may include a tracking mechanism that may be used to confirm that one or more particular exam sequences were followed properly and to specific a level of detail to determine differential diagnosis.

One or more embodiments of the present disclosure may improve standardization of standardized patient and trainee (e.g., learner) interaction requirements, which may be to the level of credentialing with ability to measure and monitor the trainee (e.g., learner) performance. Embedded technology in some embodiments of the present disclosure may allow confirmation of assessment approach and quality of information obtained during assessment by the trainee (e.g., learners) of the standardized patient during the patient assessment phase of a simulation as a mechanism to accommodate standardization. In some embodiments, recording of trainee (e.g., learner) interaction may provide detail of events in a debriefing procedure.

Some embodiments of the present disclosure may include wired or wireless delivery of parameters from a central instructing apparatus 302 (e.g., a control interface (computer)) to the garment(s). The one or more garments 200 (e.g., suits) may receive a wireless signal independently or en mass.

In one or more embodiments, the garments 200 may include pressure/location sensors to note an area being interrogated; an ability to make masses/tissue density changes (e.g., pulses, masses, etc.); a capability of venous/arterial bleeding; a pain site/characteristic locator for the standardized patient (e.g., signal of increased pain, referred pain, etc.); and the ability to create smell cues (e.g., ketoacidosis, halitosis, flatulence, etc.).

Garments 200 of the present disclosure may be constructed with one or more of the following design parameters: standardized patient comfort (e.g., temperature control, ease of getting into, wearing and getting out of garment 200; able to fit multiple body frames (slender, large, obese) and types (male/female)); may be capable of masking standardized patient's normal physiology sounds/anatomy; may include various surface areas to cover (head/neck, half of body (upper or lower), total body, etc.); may have the ability to control changes remotely via software interface; may include communication between standardized patent and operator (e.g., simulation director, educator, etc.); and may have the ability to monitor the garment 200 using common diagnostic devices (blood pressure cuff, art line, etc.).

The garments 200 and/or systems 300 of the present disclosure may be useful in a wide variety of markets for use in medical simulation, such as the following: high fidelity simulation centers; military training (e.g., mass and localized casualties); hospital based medical training programs; medical schools; nursing and allied health training programs; surgical departments; standardized patient (actor) programs; medical societies (e.g., maintenance of certification programs); national, state, and local government disaster training programs; commercial training centers in health care; veterinary medicine programs; applications in media (e.g., Hollywood productions, etc.) for entertainment and education productions.

The complete disclosure of the patents, patent documents, and publications cited herein are incorporated by reference in their entirety as if each were individually incorporated.

Illustrative embodiments have been discussed and reference has been made to possible variations within the scope of this disclosure. These and other variations and modifications will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A physiology simulation garment comprising:
a garment body adapted to be worn by a person; and
a physiology condition generator operatively connected to the garment body, wherein the generator generates a selected sensory output indicative of a selected simulated physiological condition.

2. The garment of claim 1, wherein the selected sensory output comprises one or more of: a selected auditory output, a selected visible output, a selected olfactory output, and a selected somatosensory output.

3-5. (canceled)

6. The garment of claim 1, wherein the generator simultaneously generates a plurality of selected sensory outputs.

7. The garment of claim 1, wherein the generator generates a plurality of selected sensory outputs that emit from different portions of the garment body.

8. The garment of claim 1, wherein the physiology condition generator comprises a bioelectric signal generator generating a selected electrical output indicative of a selected simulated physiological condition.

9. (canceled)

10. The garment of claim 1, wherein the physiology condition generator comprises an ultrasound image generator generating selected images indicative of a selected simulated physiological condition.

11. The garment of claim 1, further comprising an input sensing apparatus.

12-13. (canceled)

14. The garment of claim 1, wherein the garment comprises a torso section.

15. The garment of claim 1, further comprising one or more fluid reservoirs operatively connected to the garment body.

16. (canceled)

17. A system comprising:
one or more physiology simulation garments, wherein each physiology simulation garment comprises:
a garment body adapted to be worn by a person; and
a physiology condition generator operatively connected to the garment body, wherein the generator generates a selected sensory output indicative of a selected simulated physiological condition; and
a central instructing apparatus operatively connected to at least one of the one or more garments.

18. The system of claim 17, wherein the central instructing apparatus is operatively connected to at least one physiology condition generator of the one or more garments.

19. The system of claim 17, further comprising an eyewear simulation apparatus adapted to be worn by a person and operatively connected to the central instructing apparatus.

20. The system of claim 17, further comprising a communication apparatus adapted to be worn by the person and operatively connected to the central instructing apparatus.

21-22. (canceled)

23. The system of claim 17, wherein the system is capable of synchronizing at least one selected sensory output of the physiology condition generator with an input to the input sensing apparatus.

24. (canceled)

25. A method of simulating a physiological condition, the method comprising:
selecting a sensory output that is indicative of a selected simulated physiological condition; and
generating the selected sensory output using a physiology condition generator operatively connected to a garment body.

26. A method according to claim 25, wherein the selected sensory output comprises one or more of: an auditory output, a selected bioelectric signal, a selected visible output, a selected olfactory output, a selected somatosensory output, a selected image.

27-31. (canceled)

32. A method according to claim 25, wherein the method comprises selecting a plurality of sensory outputs and generating the selected plurality of sensory outputs simultaneously from the garment body.

33. A method according to claim 32, wherein the selected plurality of sensory outputs emit from different portions of the garment body.

34-35. (canceled)

36. A method according to claim 25, wherein the method further comprises generating the selected sensory output at a plurality of garment bodies, wherein each garment body of the plurality of garment bodies comprises a physiology condition generator operatively connected to the garment body, and wherein each garment body of the plurality of garment bodies is operatively connected to a central instructing apparatus.

37. (canceled)

38. A method according to claim 25, wherein the method further comprises communicating instructions to a person wearing the garment body.
